(19) United States
(12) Patent Application Publication
(10) Pub. No.: US 2020/0143225 A1
(43) Pub. Date: May 7, 2020

(54) SYSTEM AND METHOD FOR CREATING REPORTS BASED ON CROWDSOURCED INFORMATION

(71) Applicant: INTELLI NETWORK CORPORATION, Calgary Alberta (CA)

(72) Inventor: Kamea Aloha LAFONTAINE, Calgary (CA)

(21) Appl. No.: 16/669,784

(22) Filed: Oct. 31, 2019

Related U.S. Application Data
(60) Provisional application No. 62/754,058, filed on Nov. 1, 2018.

(51) Int. Cl. G06N 3/02; G06Q 50/26; H04W 8/18

(52) U.S. Cl. CPC G06N 3/02; H04W 8/18; G06Q 50/265

(57) ABSTRACT

A system and method for constructing an output report based on crowdsourced information, preferably according to an AI (artificial intelligence) model. The AI model may include machine learning and/or deep learning algorithms. The crowdsourced information may be obtained in any suitable manner, including but not limited to written text, such as a document, or audio information. The audio information is preferably converted to text before analysis.

### FIELD OF THE INVENTION

The present invention provides a system and method for preparing reports based on analysis of crowdsourced information, and in particular, to such a system and method for creating such reports based upon crowdsourced information according to an AI (artificial intelligence) model.

### BACKGROUND OF THE INVENTION

Analysis of crowdsourced information is a difficult problem to solve. Currently such analysis largely relies on manual labor to review the crowdsourced information. This is clearly impractical as a large scale solution.

For example, for reporting crimes and tips related to crimes, crowdsourced information can be very valuable. But simply gathering large amounts of tips is not useful, as the information is of widely varying quality and may include errors or biased information, which further reduces its utility. Currently the police need to review crime tips manually, which requires many person hours and makes it more difficult to fully use all received information.

### BRIEF SUMMARY OF THE INVENTION

The present invention, in at least some embodiments, relates to a system and method for analyzing crowdsourced information, preferably according to an AI (artificial intelligence) model, to prepare a report. The AI model may include machine learning and/or deep learning algorithms. The crowdsourced information may be obtained in any suitable manner, including but not limited to written text, such as a document, or audio information. The audio information is preferably converted to text before analysis.

By “document”, it is meant any text featuring a plurality of words. The algorithms described herein may be generalized beyond human language texts to any material that is susceptible to tokenization, such that the material may be decomposed to a plurality of features.

The crowdsourced information may be any type of information that can be gathered from a plurality of user-based sources. By “user-based sources” it is meant information that is provided by individuals. Such information may be based upon sensor data, data gathered from automated measurement devices and the like, but is preferably then provided by individual users of an app or other software as described herein.

Preferably the crowdsourced information includes information that relates to a person, that impinges upon an individual or a property of that individual, or that is specifically directed toward a person. Non-limiting examples of such crowdsourced types of information include crime tips, medical diagnostics, valuation of personal property (such as a house) and evaluation of candidates for a job or for a placement at a university.

Preferably the process for analyzing the information and creating the report includes removing any emotional content or bias from the crowdsourced information. For example, crime relates to people personally—whether to their body or their property. Therefore, crime tips impinge directly on people's sense of themselves and their personal space. Desensationalizing this information is preferred to prevent errors of judgement. For these types of information, removing any emotionally laden content is important to at least reduce bias.

Preferably, the evaluation process also includes determining a gradient of severity of the information, and specifically of the situation that is reported with the information. For example and without limitation, for crime, there is typically an unspoken threshold, gradient or severity in a community that determines when a crime would be reported. For a crime that is not considered to be sufficiently serious to call the police, the app or other software for crowdsourcing the information may be used to obtain the crime tip, thereby providing more intelligence about crime than would otherwise be available.

Such crowdsourcing may be used to find the small, early beginnings of crime and map the trends and reports for the community. Furthermore, the report may be used to map out crime occurrences according to time and/or spatial constraints, which may further provide intelligence regarding the underlying causes of the crime.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions.

Software (e.g., an application, computer instructions) which is configured to perform (or cause to be performed) certain functionality may also be referred to as a “module” for performing that functionality, and also may be referred to a “processor” for performing such functionality. Thus, processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions - which can be a set of instructions, an application, software—which are operable on a computational device (e.g., a processor) to cause the computational device to conduct and/or achieve one or more specific functionality.

Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIGS. 1A-1C show exemplary illustrative non-limiting schematic block diagram of systems for processing incoming information by using various types of artificial intelligence (AI) techniques including but not limited to machine learning and deep learning, and for creating reports based on this information;

FIGS. 2A and 2B show non-limiting exemplary methods for analyzing received information from a plurality of users through a crowdsourcing model of receiving user information in a method that preferably also relates to artificial intelligence and for creating reports based thereon;

FIGS. 3A and 3B relate to non-limiting exemplary systems and flows for providing information to an artificial intelligence system with specific models employed and then analyzing it;

FIG. 4 relates to a non-limiting exemplary flow for analyzing information by an artificial intelligence engine as described herein to create a report;

FIG. 5 relates to a non-limiting exemplary flow for training the AI engine as described herein;

FIG. 6 relates to a non-limiting exemplary method for obtaining training data for being able to create a report, through training an AI engine;

FIG. 7 relates to a non-limiting exemplary method for assembling a temporal sequence according to at least some embodiments;

FIG. 8 relates to a non-limiting exemplary method, for determining a geographic sequence according to at least some embodiments; and

FIG. 9 relates to a non-limiting exemplary method for basic report construction.

### DESCRIPTION OF AT LEAST SOME EMBODIMENTS

The present invention, in at least some embodiments, relates to a system and method for analyzing input crowdsourced information, preferably according to an AI (artificial intelligence) model. The AI model may include machine learning and/or deep learning algorithms. The crowdsource information may be obtained in any suitable manner, including but not limited to written text, such as a document, or audio information. The audio information is preferably converted to text before analysis.

By “document”, it is meant any text featuring a plurality of words. The algorithms described herein may be generalized beyond human language texts to any material that is susceptible to tokenization, such that the material may be decomposed to a plurality of features.

Various methods are known in the art for tokenization. For example and without limitation, a method for tokenization is described in Laboreiro, G. et al (2010, Tokenizing micro-blogging messages using a text classification approach, in ‘Proceedings of the fourth workshop on Analytics for noisy unstructured text data’, ACM, pp. 81-88).

Once the document has been broken down into tokens, optionally less relevant or noisy data is removed, for example to remove punctuation and stop words. A non-limiting method to remove such noise from tokenized text data is described in Heidarian (2011, Multi-clustering users in twitter dataset, in ‘International Conference on Software Technology and Engineering, 3rd (ICSTE 2011)’, ASME Press). Stemming may also be applied to the tokenized material, to further reduce the dimensionality of the document, as described for example in Porter (1980, ‘An algorithm for suffix stripping’, Program: electronic library and information systems 14(3), 130-137).

The tokens may then be fed to an algorithm for natural language processing (NLP) as described in greater detail below. The tokens may be analyzed for parts of speech and/or for other features which can assist in analysis and interpretation of the meaning of the tokens, as is known in the art.

Alternatively or additionally, the tokens may be sorted into vectors. One method for assembling such vectors is through the Vector Space Model (VSM). Various vector libraries may be used to support various types of vector assembly methods, for example according to OpenGL. The VSM method results in a set of vectors on which addition and scalar multiplication can be applied, as described by Salton & Buckley (1988, ‘Term-weighting approaches in automatic text retrieval’, Information processing & management 24(5), 513-523).

To overcome a bias that may occur with longer documents, in which terms may appear with greater frequency due to length of the document rather than due to relevance, optionally the vectors are adjusted according to document length. Various non-limiting methods for adjusting the vectors may be applied, such as various types of normalizations, including but not limited to Euclidean normalization (Das et al., 2009, ‘Anonymizing edge-weighted social network graphs’, Computer Science, UC Santa Barbara, Tech. Rep. CS-2009-03); or the TF-IDF Ranking algorithm (Wu et al, 2010, Automatic generation of personalized annotation tags for twitter users, in ‘Human Language Technologies: The 2010 Annual Conference of the North American Chapter of the Association for Computational Linguistics’, Association for Computational Linguistics, pp. 689-692).

One non-limiting example of a specialized NLP algorithm is word2vec, which produces vectors of words from text, known as word embeddings. Word2vec has a disadvantage in that transfer learning is not operative for this algorithm. Rather, the algorithm needs to be trained specifically on the lexicon (group of vocabulary words) that will be needed to analyze the documents.

Optionally the tokens may correspond directly to data components, for use in preparing the output report as described in greater detail below. The tokens may also be combined to form one or more data components, for example according to the type of information requested. For example, for crime tip or report, a plurality of tokens may be combined to form a data component related to the location of the crime. Preferably such a determination of a direct correspondence or of the need to combine tokens for a data component is determined according to natural language processing.

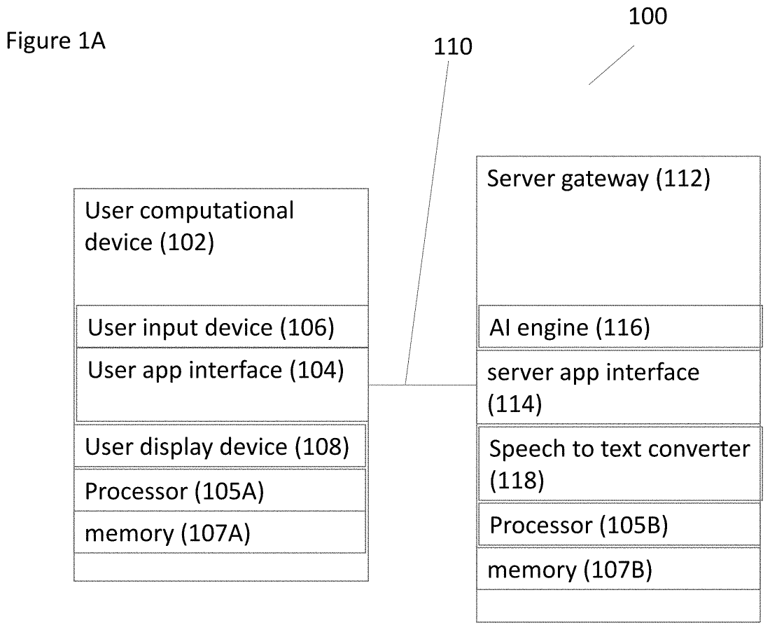

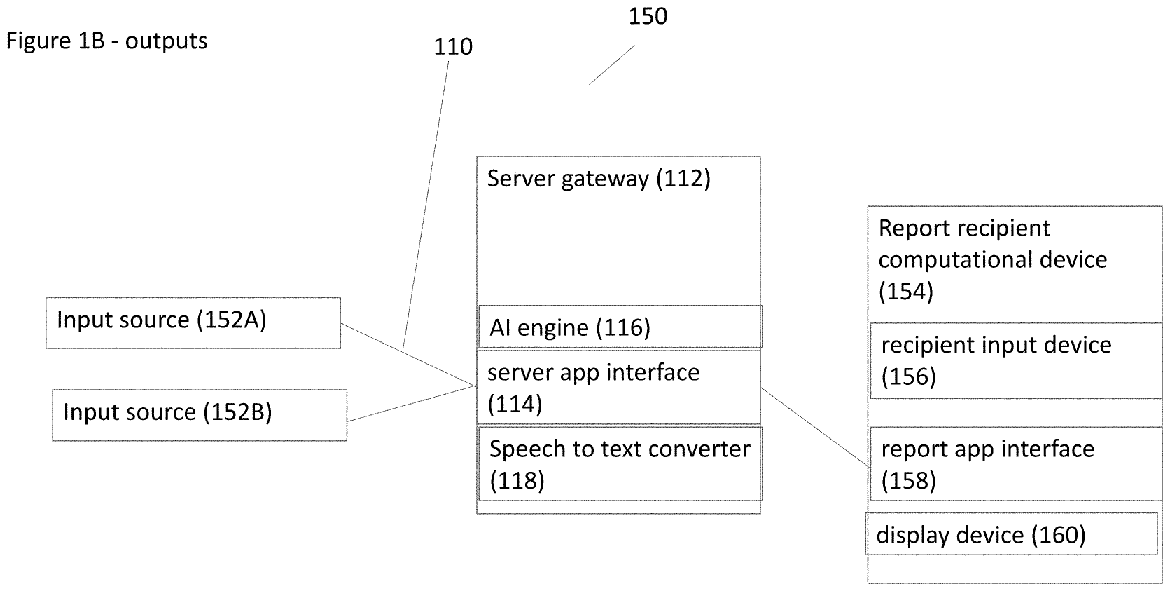

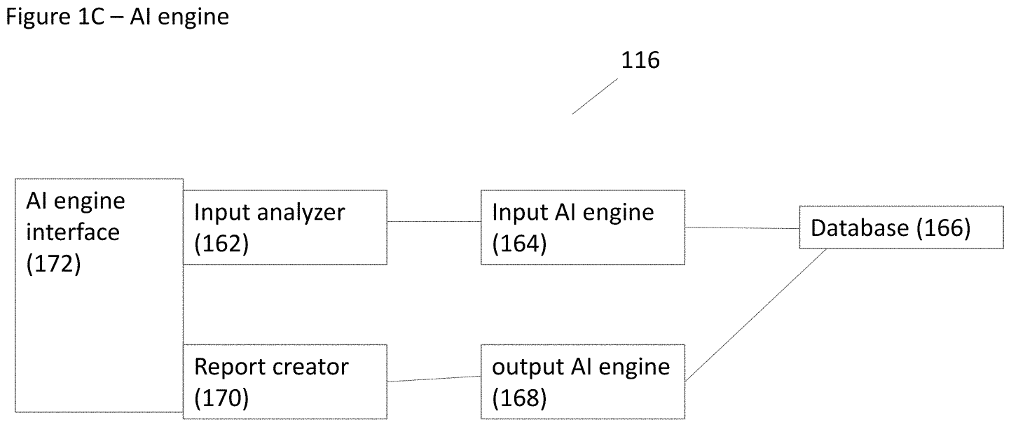

Turning now to the Figures, FIG. 1A shows an exemplary illustrative non-limiting schematic block diagram of a system for processing incoming information by using various types of artificial intelligence (AI) techniques including but not limited to machine learning and deep learning. As shown in the system 100, there is provided a user computational device 102 in communication with the server gateway 112 through a computer network 110 such as the internet for example.

User computational device 102 includes the user input device 106, the user app interface 104, and user display device 108. The user input device 106 may optionally be any type of suitable input device including but not limited to a keyboard, microphone, mouse, or other pointing device and the like. Preferably user input device 106 includes a list, a microphone and a keyboard, mouse, or keyboard mouse combination.

User display device 108 is able to display information to the user for example from user app interface 104. The user operates user app interface 104 to intake information for review by an artificial intelligence engine being operated by server gateway 112. This information is taken in from user app interface 104 through the server app interface 114 and may optionally also include a speech to text converter 118 for converting speech to text. The information analyze range in 116 preferably takes the form of text and may actually take the form of crime tips or tips about a reported or viewed crime.

Preferably AI engine 116 receives a plurality of different tips or other types of information from different users operating different user computational devices 102. In this case, preferably user app device 104 and or user computational device 102 is identified in such a way so as to be able to sort out duplicate tips or reported information, for example by identifying the device itself or by identifying the user through user app interface 104.

FIG. 1B shows a non-limiting, exemplary system for creating a report output from input information that has been analyzed, for example through machine learning. As shown in a system 150, there's provided a plurality of input sources 152, show as 152A and 152B, for the purpose of illustration only and without any intention of being limiting.

These sources provide their information through computer network 110.

Components with the same reference number as for FIG. 1A have the same or similar function. The information is received by server gateway 112 and analyzed then by AI engine 116, as previously described. The information is provided, then, after analysis through server F interface 114, to a report app interface 158. A report recipient computational device 154 is preferably able to receive a report through an assembly performed by AI engine 116, which may for example assemble data obtained from a plurality of different data sources, such as for example input sources 152A and B, into a report after analysis. For example with regard to the non-limiting illustrative situation of a crime report, different crime tips could be provided. For example, through user apps, and/or social media and/or other sources and they assembled by AI engine 116 into a coherent crime report for example, relating to a particular burglary and evidence has suggests that it happened and who the perpetrator may have been, or the statistic such as the rate of certain crimes such as burglaries in a particular area over a particular period of time, whether it is rising or falling.

The recipient through recipient computational device 154 is preferably able to input information through recipient input 156, and is able to review the report and display the information through display device 160. Report app interface 158 permits communication with a-engine 116 to review the types of data to be included, the types of analysis to be performed, and the types of output to be included in the report.

FIG. 1C relates to a non-limiting exemplary AI engine 116, which was previously shown with regard to FIGS. 1A and 1B. In this non-limiting example an AI engine interface 172 enables AI engine 116 to interface with other components on the server gateway which is not shown. AI engine interface 172 preferably interacts with an input and analyzer 162, which analyzes the input information such as for example information from a plurality of sources. The input AI engine 164 then analyzes this information, for example the aggregated to determine its quality, to group information according to a particular incident or according to other markers of information which can be helpful later on for determining the final report. This information is then stored in database 166.

When a recipient user wishes to request report, or when a report is otherwise requested, for example as it was previously described in FIG. 1B, the request is sent to AI engine interface 172, which interacts with the report creator 170. Report creator 170 provides information to an output AI engine 168, to determine the kinds of information to be obtained from database 166 and the type of analysis, for example for a single crime, or for a plurality of linked crimes, the analysis may include a temporal and geographical timeline indicating when and where certain events took place. The analysis may also include the level of confidence which has been assigned to whether or not the particular event actually occurred, such as for example, if it is known that a burglary occurred, but there's a lower probability of who the perpetrator is, then this information is indicated. For output AI engine 168 preferably the different data sources are provided, for example according to the different data qualities which have also preferably been sorted in database 166. Output AI engine 168 then provides this information for report creator 170, which puts it together into a coherent report, which is then output through AI engine interface 172.

Preferably, output AI engine 168, report creator 170, or a combination thereof, reviews the information and/or the final report to detect the presence of sensitive information. For example, such sensitive information may include without limitation personal identifying information (PII). PII is preferably removed to make the reports safe for public consumption and to achieve “privacy by design” throughout the user experience, for example to minimize harm to users in situations of swatting or doxxing. Such sensitive information may also include racially biased information, or information suffering from another type of bias, which is preferably removed in order to better inform and support the public, or other consumers of such information. Such analysis for sensitive information may be performed for example through machine learning algorithms as described herein.

User computational device 102 also comprises a processor 105A and a memory 107A. Functions of processor 105A preferably relate to those performed by any suitable computational processor, which generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, such as a memory 107A in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Also optionally, memory 107A is configured for storing a defined native instruction set of codes. Processor 105A is configured to perform a defined set of basic operations in response to receiving a corresponding basic instruction selected from the defined native instruction set of codes stored in memory 107A. For example and without limitation, memory 107A may store a first set of machine codes selected from the native instruction set for receiving information from the user through user app interface 104 and a second set of machine codes selected from the native instruction set for transmitting such information to server 106 as crowdsourced information.

Similarly, server 106 preferably comprises a processor 105B and a memory 107B with related or at least similar functions, including without limitation functions of server 106 as described herein. For example and without limitation, memory 107B may store a first set of machine codes selected from the native instruction set for receiving crowdsourced information from user computational device 102, and a second set of machine codes selected from the native instruction set for executing functions of AI engine 116.

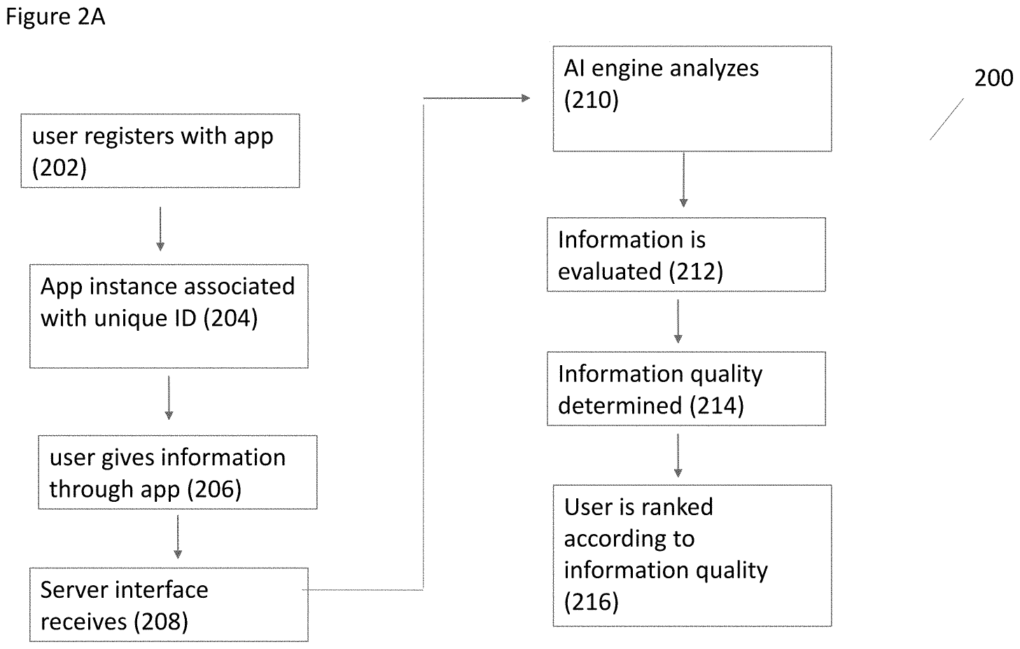

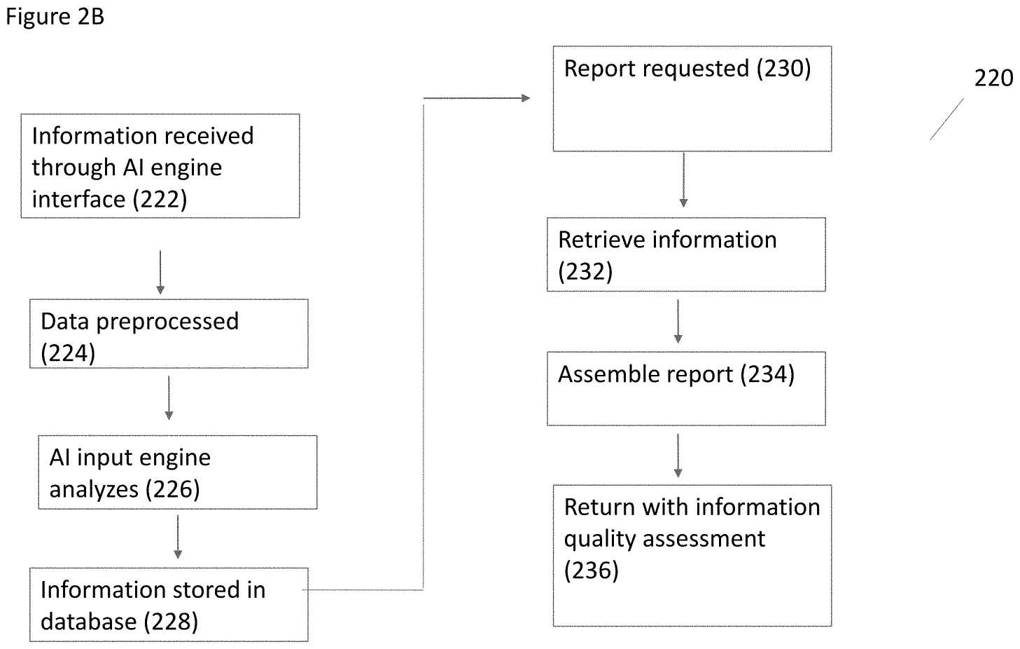

FIG. 2A shows a non-limiting exemplary method for analyzing received information from a plurality of users through a crowdsourcing model of receiving user information in a method that preferably also relates to artificial intelligence. As shown in the method 200, first the user registers with the app in 202. Next, the app instance is associated with a unique ID in 204. This unique ID may be determined according to the specific user, but is preferably also associated with the app instance. Preferably the app is downloaded and operated on a user mobile device as a user computational device, in which case the unique identifier may also be related to the mobile device.

Next, the user gives information through the app in 206, which is received by the server interface at 208. The AI engine analyzes the information in 210 and then evaluates it in 212. After the evaluation, preferably the information quality is determined in 214. The user is then ranked according to information quality in 216. Such a ranking preferably involves comparing information from a plurality of different users and assessing the quality of the information provided by the particular user in regard to the information provided by all users.

Turning now to FIG. 2B there is shown in a method 220 that information received through AI engine interface 222 is preferably analyzed and pre-processed for example through data pre-processing 224. The AI input engine analyzes it in 226 and information stored in a database 228. Once a report is requested 230 then the information is retrieved in 232, according to the request made in the report. For example, the report as previously described may request information, leading to a single crime or a linked series of crime in the case of crime data, or information may be refutably statistical relating to the rate of crime in a particular area over a particular time.

The information that is retrieved in 232 preferably is assembled in 234 by an AI engine which is able to determine which information should be included, for example according to the relative weights of the information. For example, if certain information has a greater probability of being correct, this information is given greater weight and this should be indicated in the final report which is assembled in 234. Then, the report is preferably returned with the information quality assessed in 236 to indicate which information is likely to be correct and which other information is of lower or more dubious quality.

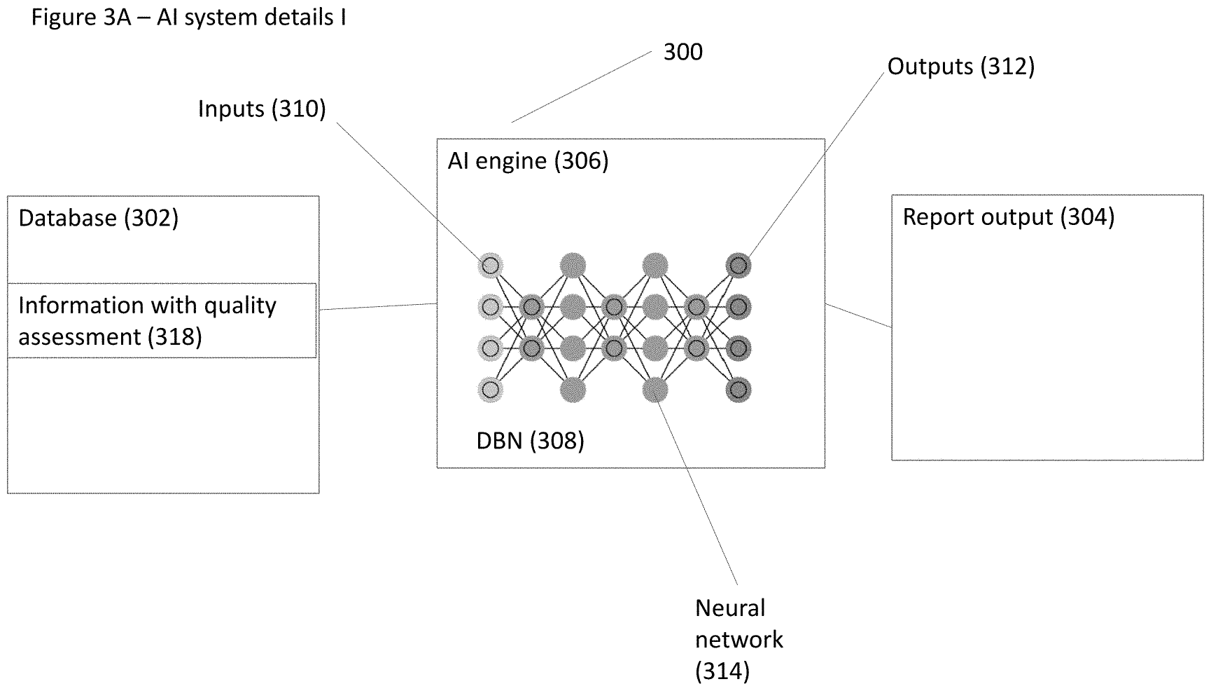

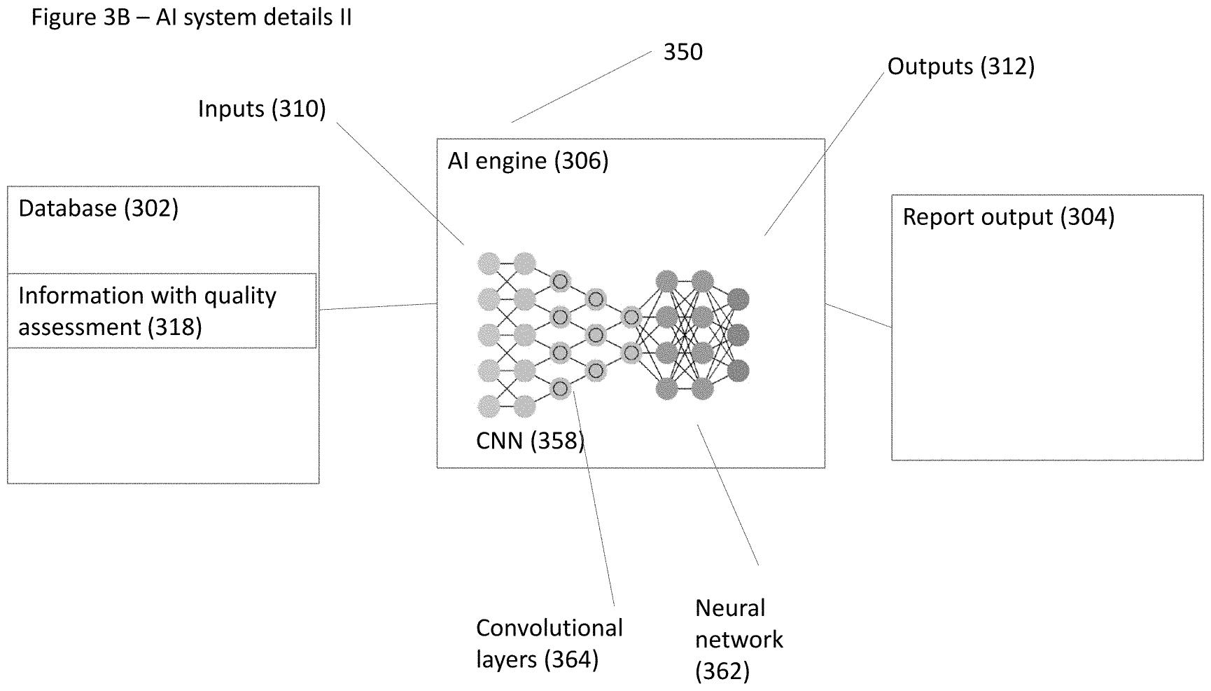

FIGS. 3A and 3B relate to non-limiting exemplary systems and flows for providing information to an artificial intelligence system with specific models employed and then analyzing it. The information had preferably previously been analyzed by tokenization, followed by analysis by a machine learning or deep learning algorithm. A tokenizer is able to break down the text inputs into parts of speech. It is preferably also able to stem the words. For example, running and runs could both be stemmed to the word run.

Turning now to FIG. 3A as shown in a system 300, information from a database preferably provided at 302. This information is preferably also analyzed with quality assessment in 318. This quality assessed information is then fed into an AI engine in 306 and a report output is provided by the AI engine in 304. In this non-limiting example, AI engine 306 comprises a DBN (deep belief network) 308. DBN 308 features input neurons 310 and neural network 314 and then outputs 312.

A DBN is a type of neural network composed of multiple layers of latent variables (“hidden units”), with connections between the layers but not between units within each layer.

FIG. 3B relates to a non-limiting exemplary system 350 with similar or the same components as FIG. 3A, except for the neural network model. In this case, a neural network 362 includes convolutional layers 364, neural network 362, and outputs 312. This particular model is embodied in a CNN (convolutional neural network) 358, which is a different model than that shown in FIG. 3A.

A CNN is a type of neural network that features additional separate convolutional layers for feature extraction, in addition to the neural network layers for classification/identification. Overall, the layers are organized in 3 dimensions: width, height and depth. Further, the neurons in one layer do not connect to all the neurons in the next layer but only to a small region of it. Lastly, the final output will be reduced to a single vector of probability scores, organized along the depth dimension. It is often used for audio and image data analysis, but has recently been also used for natural language processing (NLP; see for example Yin et al, Comparative Study of CNN and RNN for Natural Language Processing, arXiv:1702.01923v1 [cs.CL] 7 Feb. 2017).

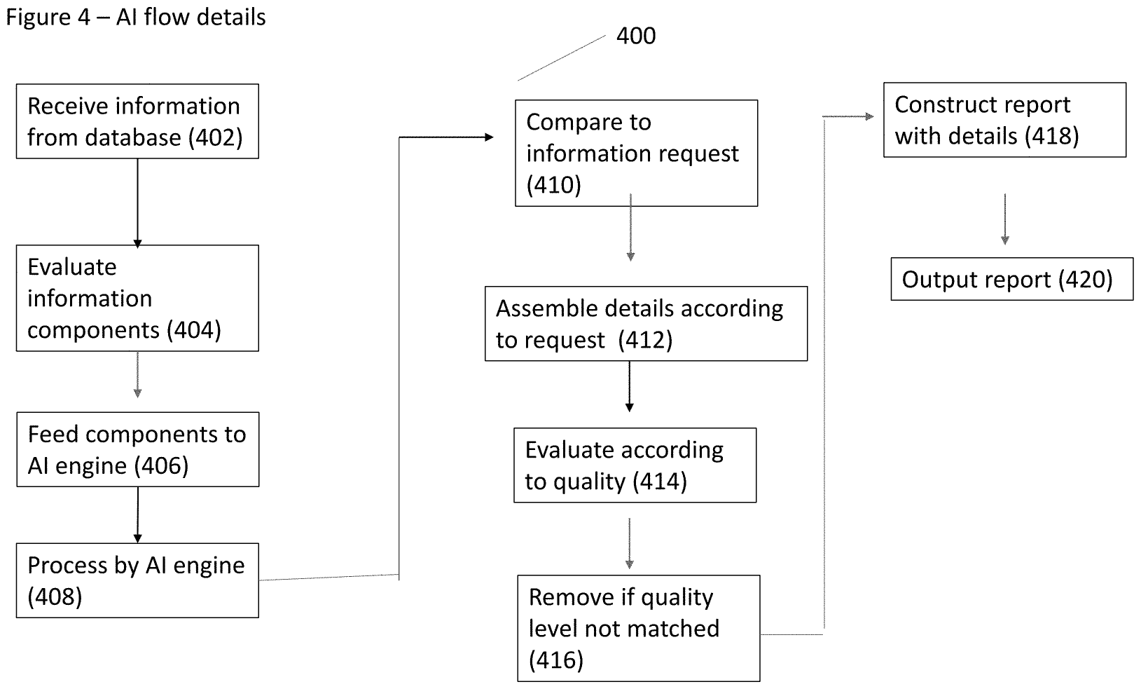

FIG. 4 relates to a non-limiting exemplary flow for analyzing information by an artificial intelligence engine as described herein to create a report. Preferably the information is assembled into a report according to desired details. In the non-limiting example of crimes for example, the details that should be included preferably relate to such factors as the location of the alleged crime, preferably with regard to a specific address, but at least with enough identifying information to be able to identify where the crime took place, details of the crime such as who committed it, or who is viewed as committing it, if in fact the crime was viewed, and also the aftermath. Was there a broken window? Did it appear that objects had been stolen? Was a car previously present and then perhaps the hubcaps were removed? Preferably the desired information includes any information which makes it clear which crime was committed, when it was committed and where.

Turning now to FIG. 4 there's provided a non-limiting exemplary method for performing a flow through an AI engine. As shown on the flow 400, information is received from the database 402. This information is preferably analyzed and considered previously for example according to data quality, the type of data included, and also the data sourced assessment as previously described. Now the information components are assembled in 404, and are preferably also evaluated in 404 to determine which one should be assembled and how they can be used. The components are then fed to the AI engine 406, and are processed by the AI engine in 408. The information after processing is compared to the information requested in 410, for example, to determine whether the information retrieved actually fulfills the conditions of the request, in terms of the details being included, and/or the level of quality which is required.

The details are preferably assembled according to the requests in 412. For example, perhaps the request relates to a crime report regarding a temporal sequence of events for a particular crime and/or a spatial sequence of events for a particular crime, or perhaps a combination of both, a map indicating both temporal and spatial events in their particular order.

The information is preferably evaluated according to the information quality in 414, so that information that is of lower quality is less likely to be correct or which may indicate a gap in the information provided is preferably flagged. Optionally, the information is removed if the quality level is not matched according to the requirements for the report in 416. For example, if the report wishes to only include information that has at least a 95% confidence level of being correct, a significant amount of information may need to be removed, but in that case then the gaps would also need to be indicated. The report is constructed with details in 418 and is outputted in 420.

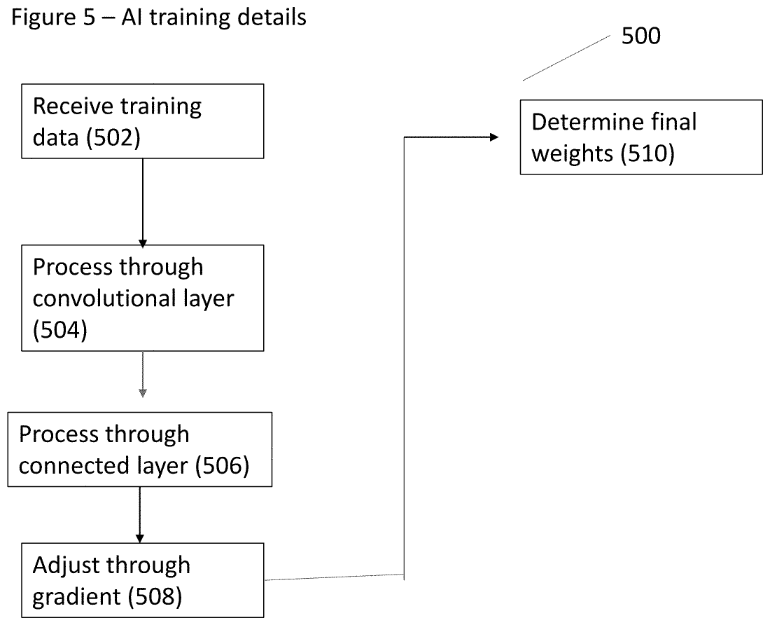

FIG. 5 relates to a non-limiting exemplary flow for training the AI engine. As shown with regard through flow 500, the training data is received in 502 and it's processed through the convolutional layer of the network in 504. This is if a convolutional neural net is used, which is the assumption for this non-limiting example. After that the data is processed through the connected layer in 506 and adjust according to a gradient in 508. Typically, a steep descent gradient is used in which the error is minimized by looking for a gradient. One advantage of this is it helps to avoid local minima where the AI engine may be trained to a certain point but may be in a minimum which is local but it's not the true minimum for that particular engine. The final weights are then determined in 510 after which the model is ready to use.

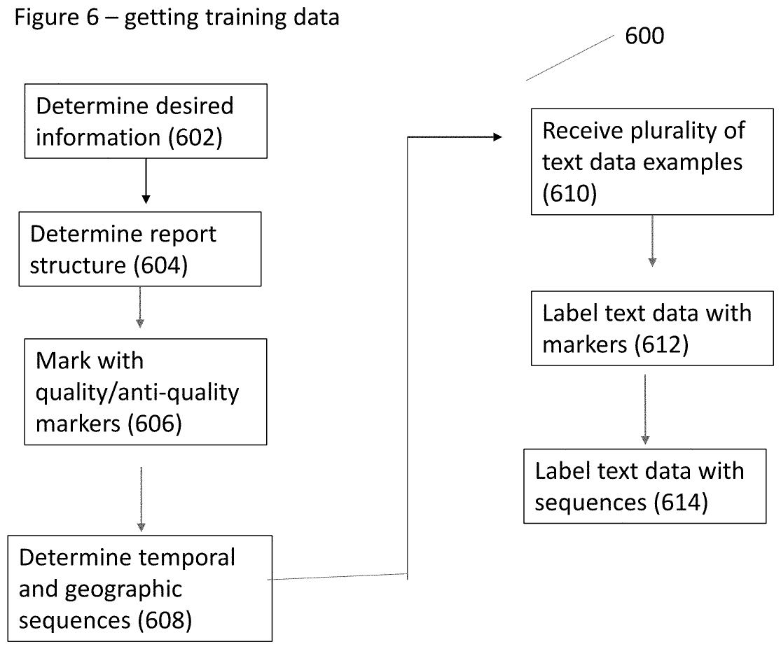

FIG. 6 relates to a non-limiting exemplary method for obtaining training data for being able to create a report, through training an AI engine. In a flow 600 the desired information that is required is preferably determined in 602. The report structures determined then in 604, again relating to the example of a crime report which may include temporal and spatial information. The report structure may include a narrative section, and optionally also a timeline, as well as a map indicating the location in space. This is important because if the timeline indicates that two events occurred in close proximity, and were allegedly performed by the same perpetrator, and that spatially it would not be possible for the perpetrator to have done both, this can be indicated according to the report structure. Next, the report is preferably marked with quality and anti-quality markers in 606. For example, relating to bias in terms of anti-quality, in terms of quality relating to a plurality of reports, perhaps a significant number of reports being received for a particular crime indicating that the likelihood of the crime occurring and the details being correct is much greater.

Next temporal and geographic sequences are preferably determined in 608 to determine the sequence of events in time and space. This is important for the training because if these sequences are given, then the AI engine can learn what it means for events to be temporally adjacent or spatially adjacent. This may also be done according to simply mapping the mouse on a map, but in terms of temporal adjacency there may also preferably be a filter which would indicate the likelihood of two events being able to occur in terms of their proximity in both space and time.

Next the plurality of text examples is received in 610 and the text quality is indicated with markers in 612. The text may also be labeled with sequences 614 again to train the AI engine how to assess and assemble temporal and geographic sequences.

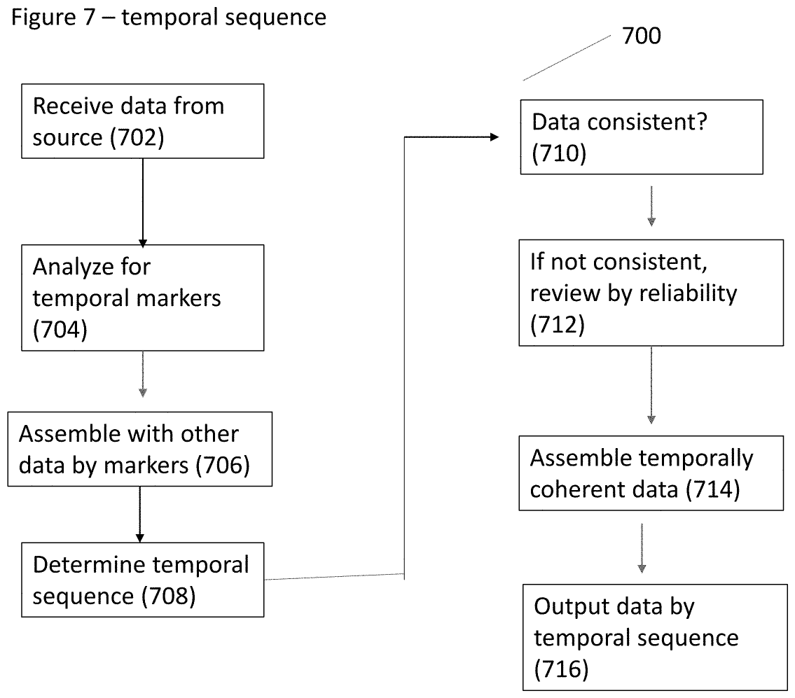

FIG. 7 relates to a non-limiting exemplary method for assembling a temporal sequence according to at least some embodiments. And shown in flow 700, data is received from a source in 702. It is analyzed for temporal markers in 704. The data is then assembled with other data according to such temporal markers in 706. For example, the time of day, the day of the week, that certain events are alleged to have occurred may be used to assemble the events in sequence according to the various crime reports, in relation to a crime report.

Next the temporal sequence is determined in 708 and the data are reviewed for consistency in 710. For example, if events are unclear as to their temporal order, this is preferably flagged. Also if two events are alleged to have occurred temporally adjacent but spatially far separated, then they may be flagged to indicate that perhaps the same perpetrator could not be involved in both events. If the data is not consistent, then it is preferably reviewed by reliability according to the source at 712. For example, if two events could not have occurred in the temporal sequence specified, whether it be for spatial reasons or because they're temporally overlapping, then optionally a selection may be made as to which sequence is more likely to be correct, or which action is more likely to have happened, according to reliability of the data source reporting that action.

Next temporally coherent data is preferably assembled in 714, to create the temporal sequence and then the data is output by temporal sequence in 716.

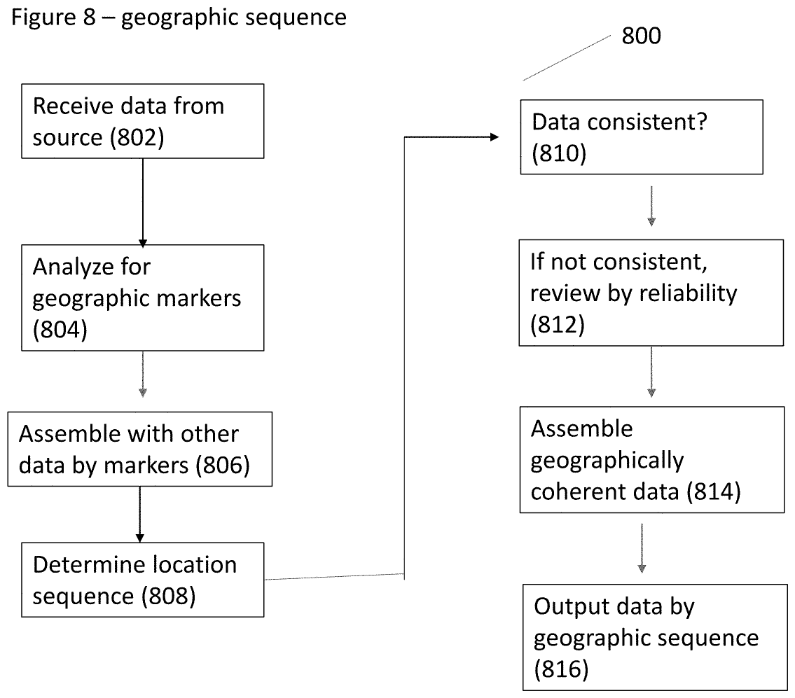

FIG. 8 relates to a non-limiting exemplary method, for determining a geographic sequence according to at least some embodiments. In the flow 800 data is received from a source in 802 and is analyzed through geographic markers in 804, addresses, store names, building names, house names, the indication of a corner, even the indication of direct coordinates if the event may have taken place, and may have been determined to have taken place in a particular location according to GPS.

Next the data is assembled with other data according to these markers in 806, so that for example the geographic markers indicate relationships in space, which may be used on a map for example to indicate a spatial sequence of events. Next the location sequence is determined in 808 according to the data received, and then consistency is evaluated in 810, so that for example, if spatially sequenced speaking it is unlikely that two events were able to occur, whether due to time constraints or due to space constraints, or also whether the data is not consistent with an event occurring. For example if an event is alleged to occur at a particular address, the description of that address does not match the building there or match what is present at that location, it is quite possible that the address is incorrect. Alternatively the description of the building or other is determined to be incorrect. If the data is not determined to be consistent in 810, that it's preferably reviewed by the reliability of the source in 812. As previously described with regard to the temporal sequence, next the geographically coherent data is assembled in 814 and the data is output by geographic sequence in 816.

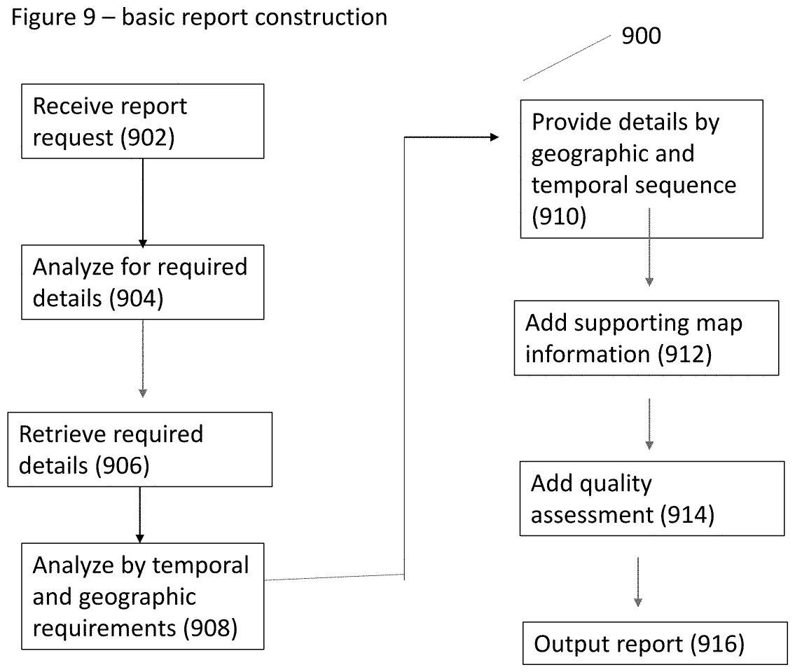

FIG. 9 relates to a non-limiting exemplary method for basic report construction. As shown in the flow 900, a report request is received in 902, and is analyzed through the required details in 904, the required details are then retrieved in 906 and are analyzed by temporal and geographical requirements in 908. This is important to determine for example consistency, again the events may have been previously analyzed separately for temporal and/or geographic consistency, but not preferably they are checked for consistency across time and space, that is across temporal and geographical sequencing. The details are then preferably provided by geographic and temporal sequence in 910, optionally was supporting that information in 912. A quality system is preferably added in 914 and the report is output in 916. This combination enables a person who may be reviewing this report to review the report for accuracy in terms of geographic and temporal sequence, to also review it in regards to accuracy in terms of the supporting map information, and they consider whether or not the quality assessment indicates that perhaps one or more events which have been described in space or time, that is temporally or geographically, may have not occurred according to that sequence, may not have occurred at all, or may not have occurred as described because the information indicates a clear lack of coherency.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for analyzing input crowdsourced information and creating a report based on the information, comprising a plurality of user computational devices, each user computational device comprising a user app; a server, comprising a server interface and an AI (artificial intelligence) engine; and a computer network for connecting said user computational devices and said server; wherein crowdsourced information is provided through each user app and is analyzed by said AI engine, wherein said AI engine determines a quality of said information received through each user app, wherein said quality of information comprises at least a level of detail and a determination of bias; and wherein said AI engine creates a report based on the information and said quality of said information.

2. The system of claim 1, wherein said server comprises a server processor and a server memory, wherein said server memory stores a defined native instruction set of codes; wherein said server processor is configured to perform a defined set of basic operations in response to receiving a corresponding basic instruction selected from said defined native instruction set of codes; wherein said server comprises a first set of machine codes selected from the native instruction set for receiving crowdsourced information from said user computational devices, and a second set of machine codes selected from the native instruction set for executing functions of said AI engine.

3. The system of claim 2, wherein each user computational device comprises a user processor and a user memory, wherein said user memory stores a defined native instruction set of codes; wherein said user processor is configured to perform a defined set of basic operations in response to receiving a corresponding basic instruction selected from said defined native instruction set of codes; wherein said user computational device comprises a first set of machine codes selected from the native instruction set for receiving information through said user app and a second set of machine codes selected from the native instruction set for transmitting said information to said server as said crowdsourced information.

4. The system of claim 3, wherein said determination of bias comprises one or more of an indication of bias against a particular feature, group or person, or a presence of an emotional word in said information.

5. The system of claim 1, wherein said AI engine comprises deep learning and/or machine learning algorithms.

6. The system of claim 5, wherein said AI engine comprises an algorithm selected from the group consisting of word2vec, a DBN, a CNN and an RNN.

7. The system of claim 1, wherein each user app is associated with a unique user identifier and wherein said AI engine further determines quality of information received through said user app according to said unique user identifier, including with regard to information previously received according to said unique user identifier.

8. The system of claim 7, wherein said user computational device comprises a mobile communication device and wherein said unique user identifier identifies said mobile communication device.

9. The system of claim 1, wherein said crowdsourced information comprises crime tips.

10. A method for analyzing input crowdsourced information, comprising operating a system according to claim 2, further comprising tokenizing input information, analyzing said tokenized information by said AI engine and determining a level of quality by said AI engine.

11. The method of claim 10, further comprising determining a temporal sequence of events from said information.

12. The method of claim 11, further comprising determining a geographical sequence of events from said information.
